(19) United States
(12) Patent Application Publication
(10) Pub. No.: US 2014/0331477 A1
(43) Pub. Date: Nov. 13, 2014

(54) FLUSH FASTENER DESIGN AND INSTALLATION

(71) Applicant: The Boeing Company, (US)

(72) Inventors: Daniel J. Kane, Mercer Island, WA (US); Thomas J. Lowe, Kent, WA (US)

(73) Assignee: The Boeing Company, Chicago, IL (US)

(21) Appl. No.: 13/889,268

(22) Filed: May 7, 2013

(51) Int. Cl. F16B 19/00

(52) U.S. Cl. CPC F16B 19/00
USPC 29/525.01; 411/500

(57) ABSTRACT

A plurality of fasteners is installed in an aerodynamic surface of an aircraft. Holes for shanks of the fasteners and countersinks for heads of the fasteners are drilled. The countersinks are drilled at an included angle between 100 and 180 degrees. Fasteners having a ratio of head-to-shank diameter of less than 2.0 are installed.

### BACKGROUND

Fasteners protruding from an aerodynamic surface of an aircraft can contribute to aerodynamic drag. The drag increases fuel consumption, which increases aircraft operating costs.

It is desirable to reduce aerodynamic drag.

### SUMMARY

According to an embodiment herein, a method of installing a plurality of fasteners in an aerodynamic surface of an aircraft comprises drilling holes for shanks of the fasteners and countersinks for heads of the fasteners, wherein the countersinks are drilled at an included angle between 100 and 180 degrees. The method further comprises installing fasteners having a ratio of head-to-shank diameter of less than 2.0.

According to another embodiment herein, a method comprises drilling holes for fastener shanks and countersinks for fastener heads in an aerodynamic surface of an aircraft structure, measuring depth of each countersink, matching fasteners having multiple head heights with the measured countersink depths, and installing the fasteners into the countersinks having the matching countersink depths.

According to another embodiment herein, an aircraft comprises a structure having an aerodynamic surface, and a plurality of fasteners installed into the surface, each of the fasteners having a ratio of head-to-shank diameter of less than 2.0, and an included angle between 100 and 180 degrees.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a fastener.

FIG. 2 is an illustration of a first method of installing a plurality of fasteners in an aircraft structure.

FIG. 3 is an illustration of a second method of installing a plurality of fasteners in an aircraft structure.

FIG. 4 is an illustration of an aircraft.

### DETAILED DESCRIPTION

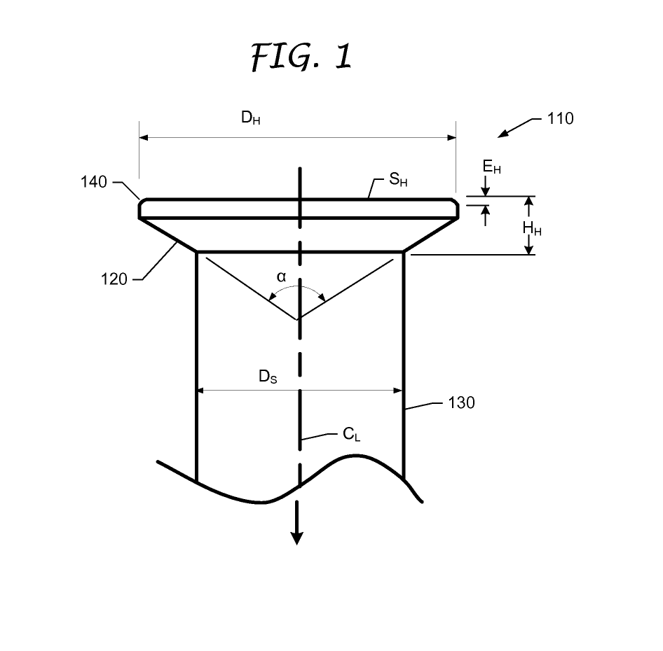

Reference is made to FIG. 1, which illustrates a fastener 110 configured for an aerodynamic surface of a structure of an aircraft. Examples of the fastener 110 include, but are not limited to, a bolt, screw, and rivet. As used herein, an aerodynamic surface refers to a surface over which air flows during flight.

The fastener 110 includes a head 120 and a shank 130. Height of the head 120 is referenced by H_{H}, and diameter of the head 120 is referenced by D_{H}. Diameter of the shank 130 is referenced by D_{S}. The fastener 110 has a ratio of head-to-shank diameter (D_{H}/D_{S}) of less than 2.0. In some embodiments, the ratio (DH/DS) is between 1.25 and 1.5.

The head 120 of the fastener 110 has an included angle α between 100 and 180 degrees. The term “included angle” refers to the angle of intersection of two intersecting sides of the head 120. In some embodiments, the included angle α is between 120 and 130 degrees.

The combination of the included angle a between 100 and 180 degrees and the ratio D_{H}/D_{S}<2.0 enables a plurality of fasteners 110 to be installed flush in an aerodynamic surface with relatively low variability in fastener flushness. During fastener installation, shank holes and countersinks are drilled into the aerodynamic surface. The combination of the included angle a between 100 and 180 degrees and the ratio D_{H}/D_{S}<2.0 provides high repeatability for making precise shank holes and countersinks that result in heads being flush with the aerodynamic surface. The included angle a allows for better control of countersink depth. The small ratio of D_{H}/D_{S}<2.0 makes the fastener head 120 less sensitive to angularity deviation relative to the aerodynamic surface. In some embodiments, all fasteners 110 may be installed in an aerodynamic surface with a perpendicularity tolerance less than ±0.5 degrees. Perpendicularity is measured as the angle between the head surface S_{H} and the shank centerline C_{L}, and the tolerance is the allowable deviation from 90 degrees. As a result, fastener flushness variability, which disturbs the air flow resulting in increased drag, is reduced.

The fastener 110 may have one or more of the following additional features, which further reduce drag. In some embodiments, surfaces of the fastener heads 120 have a perpendicularity tolerance of less than half the flushness tolerance. Flushness is measured as the distance between the aerodynamic surface S_{A} and the fastener head surface S_{H}, and the flushness tolerance is the allowable difference in distance. A positive flushness may designate the fastener 110 protruding above the surface and a negative flushness below.

In some embodiments, the fastener head 120 may have non-angular upper edges 140. Height E_{H} of the edges 140 may be between one-half and twenty times the flushness tolerance. The non-angular upper edges 140 may be radiused, elliptical, etc. This feature makes the fastener 110 have less impact on drag, even if the head sticks up into the airflow.

In some embodiments, the upper surface S_{H} of each head 120 is free of part and manufacturer identification marks. In addition the upper surface S_{H} has a surface roughness of under 40 microinches roughness average (Ra) per ASME B46.1

Aircraft fasteners are typically manufactured by forging, which does not provide adequate surface roughness or perpendicularity tolerance. Moreover, aircraft fasteners do not typically have roughness requirements. The surface roughness and/or the tight perpendicularity tolerance of the fastener 110 of FIG. 1 may be achieved by grinding or machining the fastener head 120.

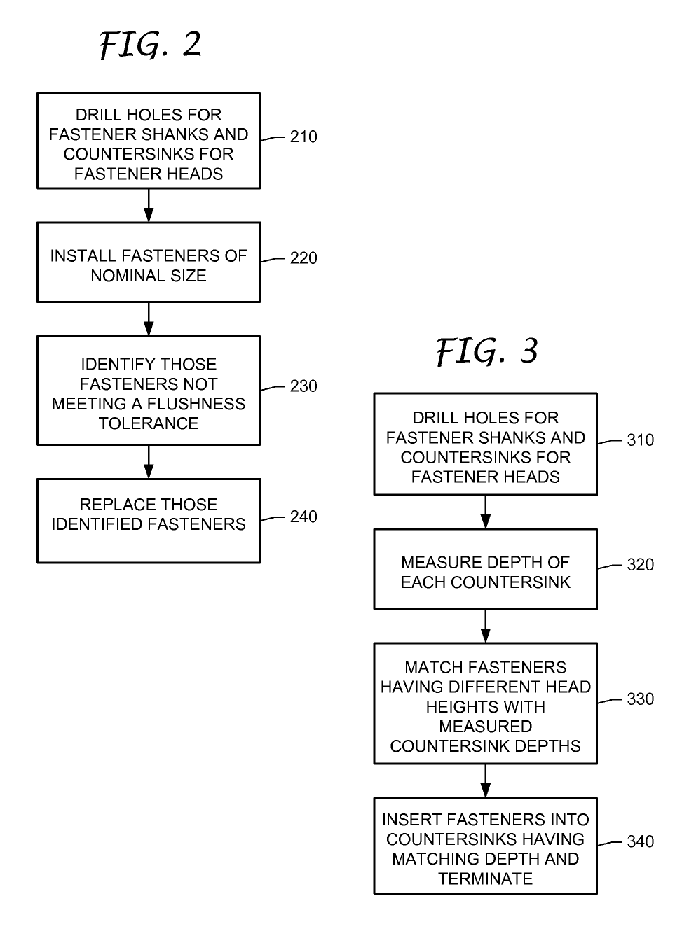

FIGS. 2 and 3 illustrate different methods of installing a plurality of the fasteners in an aerodynamic surface of an aircraft. These methods can install all fasteners in the plurality to a flushness of less than ±0.005 inches. To perform the method, different sets of fasteners will be made available for installation. Engineering requirements specify a nominal fastener size (e.g., shank diameter, head size, grip length). The different sets include fasteners of multiple head heights relative to nominal height (e.g., nominal+0.004, nominal+0.002, nominal, nominal−0.002, nominal−0.004).

All fasteners in the sets have an included angle between 100 and 180 degrees, and ratio of head-to-shank diameter that is less than 2.0. Some or all fasteners in the set may have upper head surfaces that are free of part marks and have a surface roughness of under 40 microinches roughness average (Ra). Roughness may be controlled by measuring the head surface with any standard surface roughness profilometer. Some or all of the fastener heads may have non-angular upper edges whose height is between one-half and twenty times the flushness tolerance.

Reference is now made to FIG. 2, which illustrates a first method of installing a plurality of fasteners in an aerodynamic surface of an aircraft structure. At block 210, holes for shanks of the fasteners and countersinks for heads of the fasteners are drilled into the surface. The countersinks are drilled at an included angle between 100 and 180 degrees, and the ratio of head-to-shank diameter is less than 2.0. The holes and countersinks may be drilled with a device that determines a normal vector from the surface, and drills on center with that vector.

The countersinks may leave exposed areas around the fastener heads after the fasteners have been installed. To reduce the exposed area, counterbores may be used in combination with the countersinks.

At block 220, fasteners having a nominal size are installed. The installation includes inserting the selected fasteners in the drilled shank holes and countersinks, and terminating the fasteners. The fasteners may be terminated by installing, for example, a nut, thread collar, or swaged collar.

The fasteners may be installed with a preload of less than 50% of maximum rated shank tension capability. This feature minimizes dishing of the fastener head and dimpling of and the aircraft structure.

At block 230, those installed fasteners not meeting a flushness tolerance are identified. Flushness may be measured for instance, by following airflow direction over the aerodynamic surface and measuring the flushness relative to the surface in that direction.

At block 240, those fasteners not meeting the flushness tolerance are removed and replaced with fasteners that do satisfy the flushness tolerance. Each replacement fastener has a different head height than the fastener it is replacing. For instance, measured flushness of an installed nominal fastener is off by +0.004 inches, so the nominal fastener is replaced with a fastener having a height of nominal−0.004 inches.

Perpendicularity of the installed fasteners may also be controlled. Perpendicularity may be measured with contact or non-contact instruments. An example of a contact sensor is a high precision gage. Examples of non-contact instruments include lasers and ultrasonic normality sensors.

Reference is now made to FIG. 3, which illustrates another method of installing fasteners in an aircraft structure. At block 310, holes for fastener shanks and countersinks for fastener heads are drilled in an aerospace surface of an aircraft structure. The countersinks are drilled at an included angle between 100 and 180 degrees for fasteners having a ratio of head-to-shank diameter of less than 2.0.

At block 320, depth of each countersink is measured. Countersink depth may be measured by a contact device (e.g., a gage) or a non-contact device (e.g., an ultrasonic normality sensor).

At block 330, head heights of the fasteners in the sets are matched with the measured countersink depths. At block 340, fasteners are inserted into their matched countersinks and terminated.

The method enables the fasteners to be installed to a flushness of less than ±0.005 inches. Although countersink depths are measured for all countersinks, fastener replacement following installation is reduced or eliminated.

In some embodiments of these methods, the ratio (DH/DS) is between 1.25 and 1.5. A smaller head is preferred because it is less sensitive to angularity of fastener to the hole.

In some embodiments of these methods, the included angle a is between 120 and 130 degrees. Angles shallower than 130 degrees may result in a thicker edge height E_{H} than needed and may result in larger stress risers in the aircraft structure.

The methods of FIGS. 2 and 3 may be fully or partially automated. As an example of partial automation, the drilling, fastener insertion, and measurement may be performed by robots, while the fastener termination may be performed manually. In some embodiments, the methods may be performed manually.

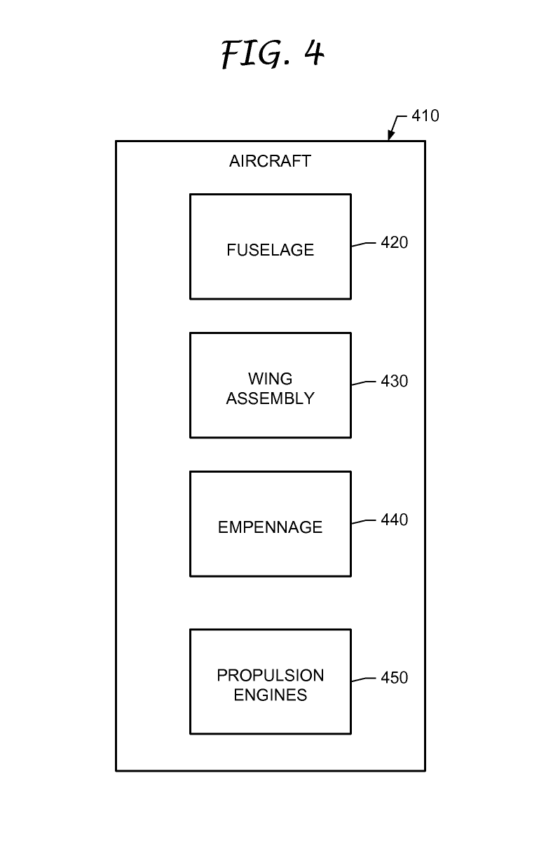

Reference is now made to FIG. 4, which illustrates an aircraft 410 including a fuselage 420, wing assembly 430, empennage 440, and propulsion engines 450. Fasteners herein are installed in surfaces where boundary layers will be relatively thin. For instance, fasteners herein may be installed in leading edges of the fuselage 420, wing assembly 430, and empennage 440. Fasteners herein may also be installed in engine inlets of the propulsion engines 450.

Fasteners herein may be installed in other surfaces of the aircraft, where boundary layers will be thicker. However, the dimensional steps in head height within the set of fasteners and the fasteners tolerances may be increased.

Although the fasteners and methods herein have been described for aircraft, they are not so limited. For instance, the fasteners and method herein may be applied to other aerospace vehicles and race cars.

1. A method of installing a plurality of fasteners in an aerodynamic surface of an aircraft, the method comprising:
drilling holes for shanks of the fasteners and countersinks for heads of the fasteners, the countersinks drilled at an included angle between 100 and 180 degrees; and
installing fasteners having a ratio of head-to-shank diameter of less than 2.0.

2. The method of claim 1, wherein the fasteners are installed with at least one of a surface roughness of less than 40 microinches roughness average and a perpendicularity tolerance less than ±0.5 degrees.

3. The method of claim 2, wherein fasteners have machined or grinded heads.

4. The method of claim 1, wherein heads of the fasteners have non-angular upper edges whose height is between one-half and twenty times a flushness tolerance.

5. The method of claim 1, wherein the fasteners are installed with a preload of less than 50% of maximum rated shank tension capability.

6. The method of claim 1, further comprising selecting the plurality of fasteners among sets of fasteners having different head heights.

7. The method of claim 1, wherein fasteners having nominal sizes are installed; and wherein the method further comprises replacing those installed fasteners that do not meet a flushness tolerance with fasteners that do meet the flushness tolerance; each replacement fastener having a different head height than the fastener it replaces.

8. The method of claim 1, wherein installing a fastener into a drilled countersink and shank hole includes measuring countersink depth; and selecting the fastener among sets of fasteners having different head heights, wherein head height of the selected fastener matches the measured countersink depth.

9. A method comprising:
drilling holes for fastener shanks and countersinks for fastener heads in an aerodynamic surface of an aircraft structure;
measuring depth of each countersink;
matching fasteners having multiple head heights with the measured countersink depths; and
installing the fasteners into the countersinks having the matching countersink depths.

10. An aircraft comprising a structure having an aerodynamic surface; and a plurality of fasteners installed into the surface, each of the fasteners having ratio of head-to-shank diameter of less than 2.0, and an included angle between 100 and 180 degrees.

11. The aircraft of claim 10, wherein the included angle is between 120 and 130 degrees.

12. The aircraft of claim 10, wherein the ratio is between 1.25 and 1.5.

13. The aircraft of claim 10, wherein heads of the fasteners have a perpendicularity tolerance of no more than ±0.5 degrees.

14. The aircraft of claim 10, wherein fastener head surfaces of the fasteners have a perpendicularity tolerance of less than half a flushness tolerance.

15. The aircraft of claim 10, wherein heads of the fasteners have non-angular upper edges whose height is between one-half and twenty times a flushness tolerance.

16. The aircraft of claim 10, wherein the fasteners have a preload of less than 50% of maximum rated shank tension capability.

17. The aircraft of claim 10, wherein fastener heads surfaces of the fasteners are free of part and manufacturer identification marks and have a surface roughness of under 40 microinches roughness average.

18. The aircraft of claim 10, wherein flushness of the fasteners is less than ±0.0005 inches.

19. The aircraft of claim 10, wherein the structure has a leading edge; and wherein the fasteners are installed in the leading edge.

20. The aircraft of claim 10, wherein the structure includes an engine inlet; and wherein the fasteners are installed in the engine inlet.
